(19) United States
(12) Patent Application Publication
(10) Pub. No.: US 2014/0000718 A1
(43) Pub. Date: Jan. 2, 2014

(54) VISUAL TEMPERATURE SENSITIVE FEEDBACK FOR CHEMICAL PRODUCT DISPENSING

(71) Applicants: Jared R. Freudenberg, St. Louis Park, MN (US); Brian P. Carlson, Lakeville, MN (US); John D. Morey, St. Paul, MN (US)

(72) Inventors: Jared R. Freudenberg, St. Louis Park, MN (US); Brian P. Carlson, Lakeville, MN (US); John D. Morey, St. Paul, MN (US)

(73) Assignee: ECOLAB USA INC., St. Paul, MN (US)

(21) Appl. No.: 13/535,838

(22) Filed: Jun. 28, 2012

(51) Int. Cl. B65D 83/00; E03B 1/00; G01K 13/02

(52) U.S. Cl. 137/1; 222/23

(57) ABSTRACT

A temperature sensitive feedback mechanism may be mounted or positioned on a heat conducting diluent conduit. The temperature sensitive feedback mechanism provides visually readable feedback regarding the temperature of the diluent to help ensure that the temperature of the diluent delivered to a chemical product dispenser satisfies a target temperature or falls within a target temperature range. The temperature sensitive feedback mechanism may include one or more temperature sensitive elements that change color in response to a change in surface temperature of diluent conduit. A user may view the visually readable temperature feedback and manually adjust the temperature of the diluent if necessary until the desired diluent temperature is reached.

### TECHNICAL FIELD

The disclosure relates to indication of water temperature for chemical product dispensing applications.

### BACKGROUND

Many commercial operations, such as those in the restaurant and hospitality industries, utilize cleaning, disinfecting, and/or sanitizing solutions in their daily operations. These so-called “use solutions” are often produced on-site by diluting a concentrated chemical product to produce a use solution having a desired concentration. Manual or automated chemical product dispensers may be utilized to dispense the chemical product and a diluent (e.g., water) to create a use solution.

### SUMMARY

In general, the disclosure is directed to a temperature sensitive feedback mechanism that indicates one or more temperature ranges for a diluent flowing through a conduit. The temperature sensitive feedback mechanism may be used to indicate water temperature in chemical dispensing applications.

In one example, the disclosure is directed to a system, comprising a chemical product dispenser that dispenses one or more chemical products, a heat conductive inlet conduit that delivers a diluent to the chemical product dispenser, and having a surface temperature that changes based on the temperature of the diluent flowing through the conduit, and a temperature sensitive feedback mechanism mounted on the conduit that provides visually readable feedback regarding the temperature of the diluent, the temperature sensitive feedback mechanism including one or more temperature sensitive elements that change color based on the surface temperature of the inlet conduit, wherein at least one of the one or more temperature sensitive elements is calibrated to exhibit a first predetermined color when the surface temperature of the inlet conduit is within a target temperature range.

In another example, the disclosure is directed to a method comprising providing a temperature sensitive feedback mechanism having one or more temperature sensitive color changing elements that provide visually readable feedback regarding the temperature of a diluent on a diluent conduit that provides the diluent to a chemical product dispenser, manually starting a flow of the diluent to the chemical product dispenser, viewing the visually readable feedback regarding the temperature of the diluent, if the visually readable feedback indicates that a temperature target is not satisfied manually adjusting the diluent temperature until the visually readable feedback indicates that the diluent temperature satisfies the target.

In another example, the disclosure is directed to a system, comprising a chemical product dispenser that dispenses one or more chemical products, the chemical product dispenser including a housing having a window therein, a heat conductive inlet conduit that delivers a diluent to the chemical product dispenser, and having a surface temperature that changes based on the temperature of the diluent flowing through the conduit, and a temperature sensitive feedback mechanism mounted on the inlet conduit and viewable through the window in the housing that provides visually readable feedback regarding the temperature of the diluent, the temperature sensitive feedback mechanism including one or more temperature sensitive elements that change color based on the surface temperature of the inlet conduit.

The details of one or more examples are set forth in the accompanying drawings and the description below. Other features and advantages of the invention will be apparent from the description and drawings, and from the claims.

### BRIEF DESCRIPTION OF DRAWINGS

FIG. 1 is a block diagram illustrating an example chemical dispenser and an example temperature sensitive feedback mechanism.

FIG. 2 shows an example temperature sensitive label.

FIG. 3 shows an example chemical product dispenser including an integrated water temperature sensitive feedback mechanism.

FIG. 4 is a flowchart illustrating an example process by which a user may adjust the temperature of a diluent delivered to a chemical product dispenser.

### DETAILED DESCRIPTION

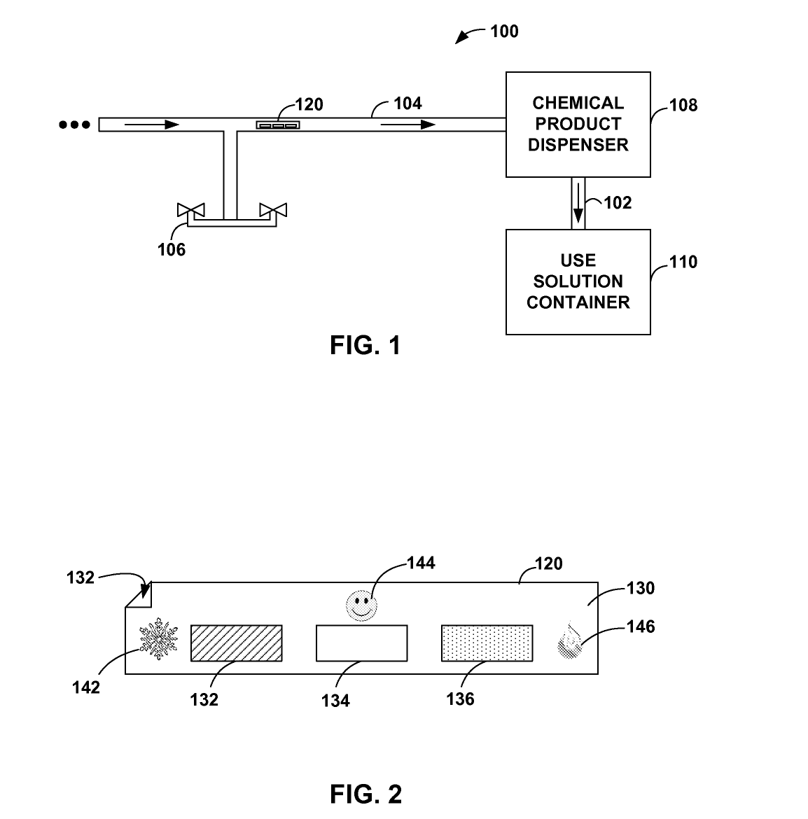

FIG. 1 is a block diagram illustrating an example chemical product dispenser 108 and an example temperature sensitive feedback mechanism 120 mounted on a diluent inlet conduit 104. In general, chemical product dispenser 108 dispenses one or more chemical products to create a use solution in use solution container 110. In this example, chemical product dispenser 108 receives a diluent, such as water, via inlet conduit 104 and delivers a use solution to use solution container 110 via outlet conduit 102. The use solution includes the diluent and a dispensed amount of the one or more chemical products. Temperature sensitive feedback mechanism 120 includes one or more visible indications of the temperature of the diluent, thus helping to ensure that the temperature of the diluent entering chemical product dispenser 108 meets a target temperature or falls within a target temperature range.

The use solution container 110 may include any of a sink, bucket, pail, bottle, or other container into which a use solution is to be dispensed. Container 110 may be the end use container from which the use solution is actually used, or it may be an intermediate container into which the use solution is dispensed and subsequently transferred to one or more other containers. In other examples, container 110 may include a dish machine, clothes washing machine, or any other type of cleaning machine into which a use solution is to be dispensed.

In the event that container 110 is a cleaning machine, the cleaning machine may include a controller that governs operation of the cleaning machine. For example, the controller may be communicatively connected with a control panel, pumps, heaters, motors, valves and/or other electronically controlled elements used during operation of one or more cleaning machine cycles. The controller may include a memory that stores various programmed instructions executed by controller to manage operation of the cleaning machine.

Dispenser 108 may be a manual, automated, or semi-automated dispenser. In an example of a manual dispenser, dispenser 108 may dispense a detergent, cleaning product, disinfectant and/or sanitizer into a sink, bucket, pail, bottle, dish machine, etc. In an example of an automated dispenser, dispenser 108 may include a dispenser controller that governs operation of the dispenser 108. Dispenser controller may include a memory that stores various programmed instructions executed by dispenser controller to manage dispensation of the one or more chemical products. Dispenser controller may be communicatively connected with cleaning machine controller (if present) or otherwise connected to receive operating information from the cleaning machine so as to control addition of the one or more chemical products to the cleaning machine at appropriate times during one or more cleaning cycles. For example, dispenser 108 may dispense a detergent during a wash cycle, and may dispense a rinse agent during a rinse cycle.

In some examples, the chemical product loaded into dispenser 108 may take the form of a solid block of chemical product concentrate. The chemical product concentrate may also take the form of pellets, tablets, granules, or other shape. A chemical product concentrate may be dispensed by dissolving and/or eroding the solid chemical product concentrate with the diluent. The amount of chemical product dispensed may be controlled by, for example, application of the diluent to the chemical product concentrate for a specified period of time, by weight, by measuring the concentration of the chemical product in the resulting use solution, or by any other means for determining when the appropriate amount of chemical product has been dispensed.

In the example of a manual chemical product dispenser, an operator may initiate flow of the diluent to the dispenser 108 by turning on a faucet or valve 106. This causes diluent (e.g., water) to flow into chemical product dispenser 108 via inlet conduit 104 in the direction indicated by the arrows.

In some examples, chemical product dispensing may require that the water temperature meets a target temperature or falls within a specified range to ensure proper chemical product dilution and/or to meet governmental or regulatory requirements. In the case of automated or partially automated dispensers, the amount of chemical product dissolved/eroded at certain water temperatures may be calibrated into the dispenser. The dispenser may thus control the approximate amount of chemical product dispensed by, for example, controlling the amount of time that the diluent is applied to the chemical product concentrate.

To help ensure that the temperature of the diluent entering chemical product dispenser 108 meets a target temperature or falls within a target temperature range, temperature sensitive feedback mechanism 120, visually readable by a user, may be mounted or positioned on a heat conducting diluent conduit, such as inlet conduit 104. For example, the conduit 104 may be made from a metal or other heat conducting material suitable for delivering potable water. Heat conducting conduit 104 changes temperature with the temperature of the diluent flowing through it. In turn, the temperature sensitive feedback mechanism 120 senses the surface temperature of the conduit, and thus indirectly senses the temperature of the diluent being delivered to dispenser 108.

Temperature feedback mechanism 120 may be implemented in any number of ways. In one example, temperature sensitive feedback mechanism 120 includes one or more temperature sensitive elements. For example, the temperature sensitive elements may include temperature sensitive, color changing elements. The one or more temperature sensitive, color changing elements may be used to provide visually readable feedback to the user concerning the temperature of the diluent being delivered to the dispenser. For example, the one or more temperature sensitive, color changing elements may provide visual feedback to the user that the diluent is at a target temperature, that the diluent is within a target temperature range, that the diluent satisfies a target temperature threshold, or other visually readable feedback concerning the temperature of the diluent.

In some examples, the one or more temperature sensitive, color changing elements may include temperature sensitive Thermochromic Liquid Crystal (TLC) elements. Example TLC elements are available from LCR Hallcrest of Glenview, Illinois. The one or more temperature sensitive, color changing elements may also include, for example, leuco dyes, hyper-color metals, thermochromic inks, thermochromic papers, thermochromic polymers, or other types of temperature sensitive compounds, thermally sensitive coatings, any combination thereof, etc.

FIG. 2 shows an example temperature feedback mechanism 120 implemented as a temperature sensitive label 120. In this example, label 120 includes one or more temperature sensitive elements (three in this example, designated by reference numerals 132, 134, 136) on a backing 130. Label 120 may include a self adhesive coating 122 (either permanent or repositionable) on a back side of label 120. The label may thus be adhered or otherwise mounted on a heat conducting conduit, such as inlet conduit 104 as shown in FIG. 1. In this example, each of the one or more elements 132, 134, 136 changes color in response to the temperature of the conduit, which in turn is indicative of the temperature of the diluent flowing through the conduit.

Label 120 senses and displays the temperature range of the surface to which it is adhered. Each of the one or more elements 132, 134, 136 changes color with the temperature of the surface, passing through various colors in sequence (e.g., orange, yellow, green, blue) before turning black at a higher temperature. The one or more elements 132, 134, 136 may be calibrated so that the element exhibiting a predefined color represents the temperature range of the water flowing through the conduit. In this example, the color changes are reversible and the colors will be observed in the reverse order upon cooling.

For example, element 132 may be calibrated to be “green” (or other chosen color) when the water temperature is within a range of approximately 85-114 degrees Fahrenheit; element 134 may be calibrated to be green (or other chosen color) when the water temperature is within a range of approximately 115-130 degrees Fahrenheit; and element 136 may be calibrated to be green (or other chosen color) when the water temperature is within a range of approximately 131-160 degrees Fahrenheit. It shall be understood, however, that label 120 of FIG. 2 is but one example of temperature sensitive label, and that other label configuration including one or more temperature sensitive elements, indicative of one or more temperatures, temperature ranges, or temperature thresholds, may also be used, and that the disclosure is not limited in this respect.

Label 120 may also include one or more icons, e.g., icons 142, 144, and 146, each associated with one of the temperature sensitive elements, e.g., elements 132, 134, and 136, respectively. In this example, a water temperature in the range indicated by element 132 means that the water flowing through the conduit is too cold for accurate dispensation of the chemical product. Icon 142 (such as a snowflake or similar cold-related icon) associated with element 132 provides a further indication to the user that, when the temperature falls within the range indicated by element 132, the water is too cold. This gives visually readable feedback to the user that the water flowing through the conduit is too cold and that the user should adjust the temperature (e.g., using the faucet controls 106) until the water temperature falls within the proper range as indicated by element 134.

A water temperature in the range indicated by element 136 means that the water flowing through the conduit is too hot for effective and/or efficient dispensation of the chemical product. Icon 146 (such as a flame or similar heat-related icon) provides further indication to the user that, when the temperature falls within the range indicated by element 136, the water temperature is too hot. This gives visually readable feedback to the user that the water flowing through the conduit is too hot and that the user should adjust the temperature (e.g., using the faucet controls 106) until the water temperature falls within the proper range as indicated by element 134.

A water temperature in the range indicated by element 134 means that the water flowing through the conduit is in the proper range for relatively effective and/or efficient dispensation of the chemical product. Icon 144 (such as a smiley face or similar affirmation icon) provides further indication to the user that, when the water temperature falls within the range indicated by element 134, the water temperature is in the proper range for accurate dispensing of the chemical product(s). This gives visually readable feedback to the user that no adjustments to the water temperature are currently required.

In other examples, the relative temperature ranges may be indicated with text, (e.g., “cold”, “OK”, or “hot”); with numerical temperature indications (e.g., “85-114”, “115-130” or “131-160”); or by any other means of indicating the appropriateness of the temperature. Again, although three temperature sensitive elements are shown, label 120 may include, one, two, three, or more temperature sensitive elements, and the disclosure is not limited in this respect.

Although a specific temperature sensitive label 120 is shown in FIG. 2, it shall be understood that many variations are possible, and that the size, shape, color, temperature ranges, number of temperature elements, icons, logos, etc. may be changed, and that the disclosure is not limited in this respect.

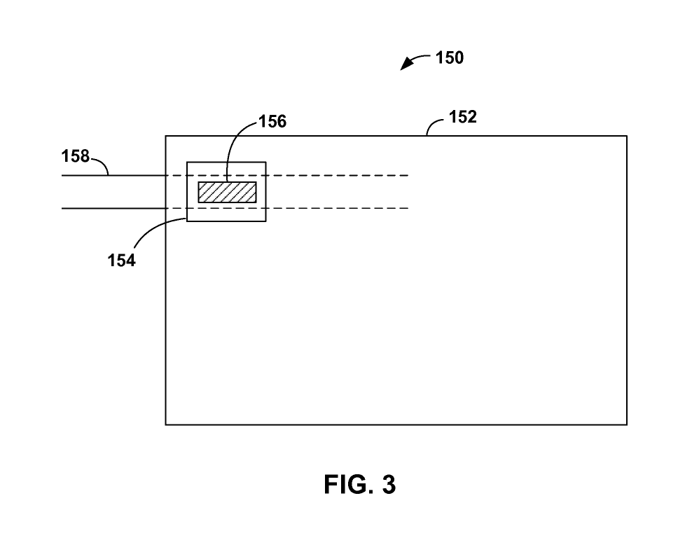

FIG. 3 is a block diagram of a chemical product dispenser 150 having a temperature sensitive feedback mechanism 156. Temperature sensitive feedback mechanism 156 is mounted on a diluent conduit 158 internal to the dispenser 150. Dispenser 150 includes a housing 152 having a window 154. Window 154 is transparent or translucent such that temperature sensitive feedback mechanism 156 is viewable through window 154. In this way, a user may view the temperature sensitive feedback mechanism 156 through window 154 to determine whether the diluent being delivered to the dispenser is at a target temperature, is within a target temperature range, or satisfies a target temperature threshold. Based on the visually readable feedback, the user may adjust the diluent temperature if necessary until the temperature sensitive feedback mechanism 156 indicates that the diluent is at a target temperature, is within a target temperature range or satisfies a target temperature threshold.

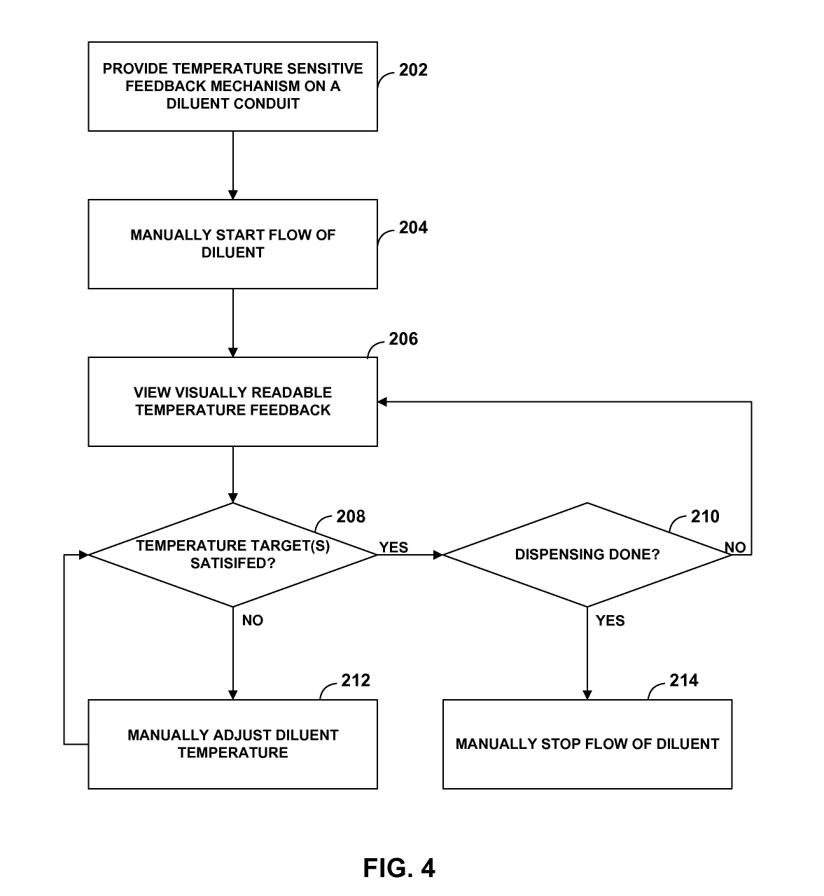

FIG. 4 is a flow chart illustrating an example process 200 by which a temperature sensitive feedback mechanism may be used to help ensure that the temperature of a diluent being delivered to a chemical product dispenser satisfies one or more target temperatures. A temperature sensitive feedback mechanism is provided on a diluent conduit that provides a diluent to the chemical product dispenser (202). The user manually starts the flow of diluent to the chemical product dispenser (204). The user views the visually readable temperature feedback regarding the temperature of the diluent on the temperature sensitive feedback mechanism (206). If the temperature target(s) are not satisfied (208), the user may adjust the diluent temperature until the visually readable temperature feedback presented on the temperature sensitive feedback mechanism indicates that the diluent temperature satisfies the target(s) (212). If the temperature target(s) are satisfied (208), and if the dispensing of the chemical product (or simply the flow of diluent) is not yet completed (210), the user continues to view the visually readable temperature feedback to monitor the temperature of the diluent (206), adjusting the temperature as necessary (212). When the dispensing is completed (210), the user manually stops the flow of diluent to the chemical product dispenser (214).

Various examples have been described. These and other embodiments are within the scope of the following claims.

1. A system, comprising:
a chemical product dispenser that dispenses one or more chemical products;
a heat conductive inlet conduit that delivers a diluent to the chemical product dispenser, and having a surface temperature that changes based on the temperature of the diluent flowing through the conduit; and
a temperature sensitive feedback mechanism mounted on the conduit that provides visually readable feedback regarding the temperature of the diluent, the temperature sensitive feedback mechanism including one or more temperature sensitive elements that change color based on the surface temperature of the inlet conduit, wherein at least one of the one or more temperature sensitive elements is calibrated to exhibit a first predetermined color when the surface temperature of the inlet conduit is within a target temperature range.

2. The system of claim 1 wherein one of the one or more temperature sensitive elements is calibrated to exhibit a second predetermined color when the surface temperature of the inlet conduit is below the target temperature range.

3. The system of claim 1 wherein one of the one or more temperature sensitive elements is calibrated to exhibit a third predetermined color when the surface temperature of the inlet conduit is above the target temperature range.

4. The system of claim 1 wherein the first, second, and third predetermined colors are the same color.

5. The system of claim 1 wherein the first, second, and third predetermined colors are different colors.

6. The system of claim 1 wherein the chemical product dispenser that dispenses one or more chemical products to one of a sink, bucket, pail, bottle, container, dish machine, washing machine, or cleaning machine.

7. The system of claim 1 wherein the one or more chemical products includes a solid block of a chemical product concentrate.

8. The system of claim 7 wherein the chemical product is dispensed by applying the diluent to the solid block of chemical product concentrate.

9. The system of claim 1 wherein at least one of the one or more temperature sensitive elements comprises at least one of a Thermochromic Liquid Crystal (TLC) element, a leuco dye, a hyper-color metal, a thermochromic ink, a thermochromic paper, or a thermochromic polymer.

10. The system of claim 1 wherein the temperature sensitive feedback mechanism comprises a temperature sensitive label.

11. The system of claim 1 wherein the temperature sensitive feedback mechanism comprises one or more icons, each icon associated with a different one of the temperature sensitive elements.

12. A method comprising:
providing a temperature sensitive feedback mechanism having one or more temperature sensitive color changing elements that provide visually readable feedback regarding the temperature of a diluent on a diluent conduit that provides the diluent to a chemical product dispenser;
manually starting a flow of the diluent to the chemical product dispenser;
viewing the visually readable feedback regarding the temperature of the diluent;
if the visually readable feedback indicates that a temperature target is not satisfied manually adjusting the diluent temperature until the visually readable feedback indicates that the diluent temperature satisfies the target.

13. The method of claim 12 further comprising, if the visually readable feedback indicates that a temperature target is not satisfied manually adjusting the diluent temperature until the visually readable feedback indicates that the diluent temperature satisfies the target.

14. The method of claim 12 wherein providing a temperature sensitive feedback mechanism comprises providing a temperature sensitive feedback mechanism having a first temperature sensitive color changing element that indicates if the diluent is too cold, a second temperature sensitive color changing element that indicates if the diluent is too hot, and a third temperature sensitive color changing element that indicates if the diluent temperature is within a target temperature range.

15. A system, comprising:
a chemical product dispenser that dispenses one or more chemical products, the chemical product dispenser including a housing having a window therein;
a heat conductive inlet conduit that delivers a diluent to the chemical product dispenser, and having a surface temperature that changes based on the temperature of the diluent flowing through the conduit; and
a temperature sensitive feedback mechanism mounted on the inlet conduit and viewable through the window in the housing that provides visually readable feedback regarding the temperature of the diluent, the temperature sensitive feedback mechanism including one or more temperature sensitive elements that change color based on the surface temperature of the inlet conduit.

16. The system of claim 15 wherein at least one of the one or more temperature sensitive elements is calibrated to exhibit a first predetermined color when the surface temperature of the inlet conduit is within a target temperature range.

17. The system of claim 15 wherein one of the one or more temperature sensitive elements is calibrated to exhibit a second predetermined color when the surface temperature of the inlet conduit is below the target temperature range.

18. The system of claim 15 wherein one of the one or more temperature sensitive elements is calibrated to exhibit a third predetermined color when the surface temperature of the inlet conduit is above the target temperature range.

19. The system of claim 1 wherein at least one of the one or more temperature sensitive elements comprises at least one of a Thermochromic Liquid Crystal (TLC) element, a leuco dye, a hyper-color metal, a thermochromic ink, a thermochromic paper, or a thermochromic polymer.

20. The system of claim 1 wherein the temperature sensitive feedback mechanism comprises a temperature sensitive label.
